(19) United States
(12) Patent Application Publication
(10) Pub. No.: US 2013/0307344 A1
(43) Pub. Date: Nov. 21, 2013

(54) RESONANCE COUPLING WIRELESS POWER TRANSFER RECEIVER AND TRANSMITTER

(71) Applicants: Sang Hoon CHEON, Daejeon (KR); Yong Hae KIM, Daejeon (KR); Myung Lae LEE, Daejeon (KR); Seung Youl KANG, Daejeon (KR); Taehyoung ZYUNG, Daejeon (KR)

(72) Inventors: Sang Hoon CHEON, Daejeon (KR); Yong Hae KIM, Daejeon (KR); Myung Lae LEE, Daejeon (KR); Seung Youl KANG, Daejeon (KR); Taehyoung ZYUNG, Daejeon (KR)

(73) Assignee: ELECTRONICS AND TELECOMMUNICATIONS RESEARCH INSTITUTE, Daejeon (KR)

(21) Appl. No.: 13/614,128

(22) Filed: Sep. 13, 2012

(30) Foreign Application Priority Data
May 16, 2012 (KR) 10-2012-0051952

(51) Int. Cl. H01F 38/14; H02J 17/00

(52) U.S. Cl. 307/104

(57) ABSTRACT

Provided are a wireless power transmission receiver and a system including the same, particularly to a receiver and transmitter transmitting power from one transmitter to a plurality of receivers at the same time by wireless. According to the present invention, the wireless power receiver comprises a receiving coil unit receiving power from a transmitter by a resonance coupling method; and a power receiving unit receiving power from the receiving coil unit to provide the power to a load resistor, wherein an input impedance of the power receiving unit is adjusted according to power consumed by a plurality of receivers. Therefore, power transmission efficiency of the wireless power receiver and transmitter can be improved.

### CROSS-REFERENCE TO RELATED APPLICATIONS

This U.S. non-provisional patent application claims priority under 35 U.S.C. §119 of Korean Patent Application No. 10-2012-0051952, filed on May 16, 2012, the entire contents of which are hereby incorporated by reference.

### BACKGROUND OF THE INVENTION

The present invention disclosed herein relates to a wireless power transmission system wherein power is transmitted to a plurality of receivers from one transmitter at the same time by wireless.

Recently, interest in wireless power transmission is increasing. In wireless power transmission, power is transmitted through a free space instead of using a cable. As the user mobile electronic devices increases, there is increasing demand for wireless devices capable of supplying power to distant places.

Wireless power transmission may be classified into an electromagnetic wave radiation method and a magnetic field inductive coupling method. The magnetic field inductive coupling method may be classified into a simple inductive method and a resonance coupling method, depending on whether resonance coupling is used.

In case of the simple inductive coupling, a power source is operated such that a first coil generates a magnetic field varying according to time. The magnetic field varying according to time applies a voltage to both sides of a second coil. The applied voltage is sent to a load resistor.

Wireless power transmission using a simple inductive coupling method has been widely used for home appliances such as vibration tooth brushes. However, the inductive coupling method has limitations such as low transmission efficiency in long distance power transmission, heating by eddy currents, and difficulties in case of charging a plurality of devices.

### SUMMARY OF THE INVENTION

The present invention provides a resonance coupling power receiver and transmitter having high power transmission efficiency although power is transmitted to a plurality of receivers by wireless.

Embodiments of the present invention provide wireless power receivers including: a receiving coil unit receiving power from a transmitter by a resonance coupling method; and a power receiving unit receiving power from the receiving coil unit to provide the power to a load resistor, wherein an input impedance of the power receiving unit is adjusted according to power consumed by a plurality of receivers, and the wireless power receiver receives power at the same time through a plurality of the receivers using one operation frequency.

In some embodiments, the power receiving unit may include: an impedance adjuster adjusting the input impedance; and an over voltage protector keeping the input impedance at a constant value although resistance of the load resistor is changed.

In other embodiments, the impedance adjuster may adjust the input impedance according to power consumed by the load resistor

In still other embodiments, the impedance adjuster may increase the input impedance as the load resistor consumes more power.

In even other embodiments, the impedance adjuster may decrease the input impedance as the load resistor consumes less power.

In yet other embodiments, the receiving coil unit may include an inductor connected in series.

In further embodiments, the receiving coil unit may include two inductors inductively coupled to each other for receiving power

In other embodiments of the present invention, a wireless power transmitters include a power generation unit generating power using a power source; and a transmitting coil unit transmitting the power at the same time to a plurality of receivers through an operation frequency by a resonance coupling method, wherein input impedances of the receivers are adjusted according to power consumed by the receivers, respectively.

In some embodiments, the power transmitter may transmit the power at the same time to a plurality of the receivers through an operation frequency.

In other embodiments, the wireless power transmitter further may include a transmission control device adjusting power generation by the power source according to a total amount of power consumed by the receivers.

In still other embodiments, the transmission control device may increase power generation by the power source as total power consumption of the receivers increases.

In even other embodiments, the transmission control device may decrease power generation by the power source as total power consumption of the receivers decreases.

In yet other embodiments, the transmitting coil unit may include an inductor connected in series.

In further embodiments, the transmitting coil unit may include two inductors inductively coupled to each other for receiving power.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a block diagram illustrating a parallel resonance-coupled wireless power receiver and transmitter;

FIG. 2 is a block diagram illustrating a series resonance-coupled wireless power receiver and transmitter;

FIG. 3 is a view specifically illustrating an input impedance illustrated in FIGS. 1 and 2;

FIG. 4 is a block diagram illustrating a parallel wireless power receiver and transmitter according to an embodiment of the present invention;

FIG. 5 is a block diagram illustrating a series wireless power receiver and transmitter according to an embodiment of the present invention;

FIG. 6 is a view specifically illustrating an input impedance of a first receiver illustrated in FIGS. 4 and 5;

FIG. 7 is a view specifically illustrating an input impedance of a second receiver illustrated in FIGS. 4 and 5;

FIG. 8 illustrates a wireless power receiver and transmitter according to an embodiment of the present invention implemented exemplarily;

FIG. 9 is a graph illustrating a power efficiency measurement result of the receiver and transmitter of FIG. 8;

FIG. 10 is a block diagram illustrating another embodiment of a wireless power receiver and transmitter according to the present invention;

FIG. 11 is a block diagram illustrating another embodiment of a wireless power receiver and transmitter according to the present invention;

### DETAILED DESCRIPTION OF PREFERRED EMBODIMENTS

The general explanation above and following specification must be understood as an example and must be considered as providing an additional explanation of a claimed invention. Reference marks are presented specifically in exemplary embodiments of the present invention and this example is illustrated on reference drawings. In any possible case, the same reference numbers are used in a specification and a drawing for referring to the same or the similar part.

A resonance-coupled wireless power receiver and transmitter is used above as an example for explaining characteristics and functions of the present invention. However, those skilled in the art can easily understand other advantages and performance of the present invention according to the contents desccribed herein.

The present invention is also embodied or applied in different embodiments. Besides, the specification within the scope, the technical features, and the other purpose of the present invention may be modified or changed according to a point of view and an application.

A resonance coupling method is based on evanescent waves coupling where electromagnetic waves move to a receiver from a transmitter through a short-distance electromagnetic field in case that the transmitter and the receiver resonate at the same frequency.

Therefore, only in case that the resonant frequencies of the receiver and the transmitter are same, power can be transmitted, and power which is not used may be reabsorbed. Also, this method does not have influence on an adjacent machine and a human body unlike other power methods. Finally, in the resonance coupling method, long-distance power is possible compared to an inductive coupling method.

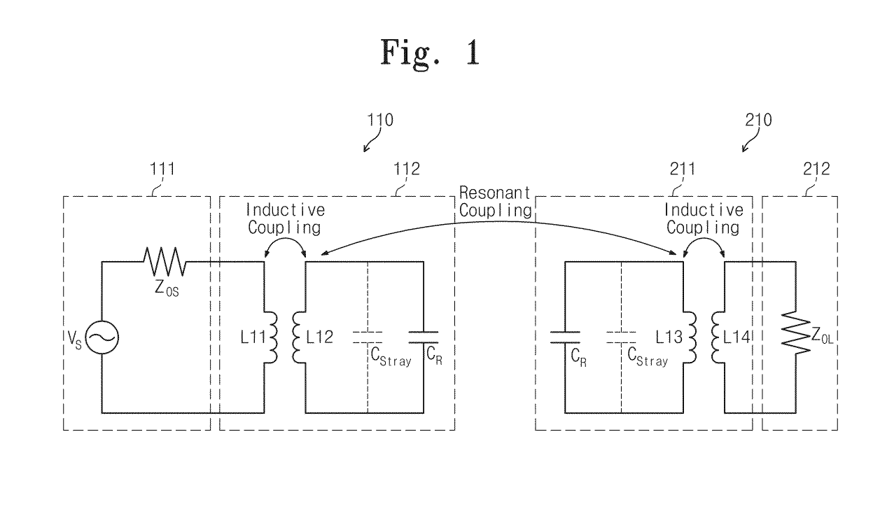

FIG. 1 is a block diagram illustrating a parallel resonance-coupled wireless power receiver and transmitter.

Referring to FIG. 1, the wireless power receiver and transmitter includes a transmitter 110, and a receiver 210. The transmitter 110 transmits power to the receiver 210 by wireless. The transmitter 110 includes a power generation unit 111, and a transmitting coil unit 112. The receiver 210 includes a receiving coil unit 211 and a power receiving unit 212

The power generation unit 111 includes a power source Vₛ and a resistor Zₒₛ. The power generation unit 111 generates power through the power source Vₛ and the generated power is provided to the transmitting coil unit 112.

The transmitting coil unit 112 includes two inductors L11 and L12, and a capacitor C_{R}. Also, the transmitting coil unit 112 may further include a stray capacitor C_{stray} having uncertain capacitance. The transmitting coil unit 112 outputs the received power in the form of a magnetic field through the inductor L11. The inductor L12 of the transmitting coil unit 112 receives the power output from the inductor L11. The inductor L11 and the inductor L12 of the transmitting coil unit 112 are inductively coupled to each other. Therefore, the inductor L11 and inductor L12 are required to be closely located. The inductor L12 of the transmitting coil unit 112 outputs the received power in the form of a magnetic field.

The receiving coil unit 211 includes two inductors L13 and L14, and a capacitor C_{R}. Also, the receiving coil unit 211 may further include a stray capacitor C_{stray} having uncertain capacitance. The inductor L13 of the receiving coil unit 211 receives the output power from the transmitting coil unit 112. Here, the receiving coil unit 211 and the transmitting coil unit 112 are resonance-coupled. Therefore, when the receiving coil unit 211 and the transmitting coil unit 112 has the same resonant frequency, a high efficient power transmission is possible. Due to the characteristics of the resonance coupling, a long distance power transmission is possible compared with the inductive coupling. That is, the inductor L12 of the transmitting unit 112 and the inductor L13 of the receiving coil unit 211 can be located a relatively long distance from each other.

The receiving coil unit 211 outputs the received power in the form of a magnetic field through the inductor L13. The inductor L14 receives the output power in the form of a magnetic field. The inductor L13 and the inductor L14 of the receiving coil unit 211 are inductively coupled to each other. Therefore, the inductor L13 and inductor L14 are required to be located a relatively adjacent distance. The power received by the inductor L14 is provided to the power receiving unit 212.

The power receiving unit 212 has input impedance Z_{OL}. The power receiving unit 212 provides the received power through the inductor L14 to the input impedance Z_{OL}. The power receiving unit 212 may be connected to a device, namely a load consuming the received power.

This system is required to meet impedance matching so that the power transmitted from the transmitter 110 to the receiver 210 is not reflected. For impedance matching, an intrinsic impedance Zₒₛ (internal resistance) of the power generation unit 111 and the input impedance Z_{OL} of the power receiving unit 212 are adjusted to optimal values.

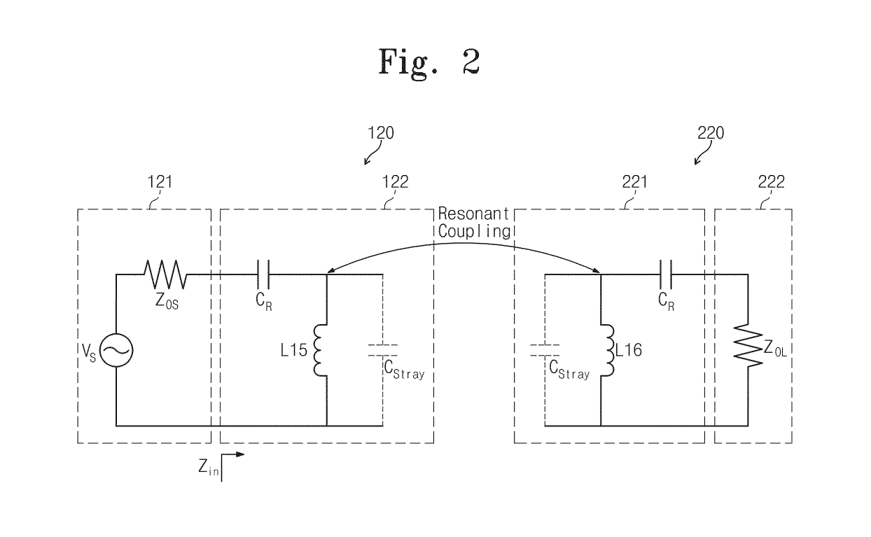

FIG. 2 is a block diagram illustrating a series resonance-coupled wireless power receiver and transmitter.

Referring to FIG. 2, the wireless power receiver and transmitter includes a transmitter 120 and a receiver 220. The transmitter 120 transmits power to the receiver 220 by wireless. The transmitter 120 includes a power generation unit 121 and a transmitting coil unit 122. The receiver 220 includes a receiving coil unit 221 and a power receiving unit 222

The power generation unit 121 includes a power source Vₛ and a resistor Zₒₛ. The power generation unit 121 generates power through the power source Vₛ and provides the generated power to the transmitting coil unit 122.

The transmitting coil unit 122 includes an inductor L15 and a capacitor C_{R}. Also, the transmitting coil unit 122 may further include a stray capacitor C_{stray} having uncertain capacitance. The transmitting coil unit 122 outputs the received power in the form of a magnetic field through the inductor L15.

The receiving coil unit 221 includes an inductor L16 and a capacitor C_{R}. Also, the receiving coil unit 221 may further include a stray capacitor C_{stray} having uncertain capacitance. The inductor L16 of the receiving coil unit 221 receives the output power from the transmitting coil unit 122. Here, the receiving coil unit 221 and the transmitting coil unit 122 are resonance-coupled. Therefore, when the receiving coil unit 221 and the transmitting coil unit 122 have the same resonant frequency, high efficient power transmission is possible. Due to the characteristics of the resonance coupling, relatively long distance power transmission is possible compared with inductive coupling. That is, the inductor L15 of the transmitting coil unit 122 and the inductor L16 of the receiving coil unit 221 can be located a relatively long distance from each other. The power received by the inductor L16 is provided to the power receiving unit 222.

The power receiving unit 222 includes an input impedance Z_{OL}. The power receiving unit 222 provides the received power through the inductor L14 to the input impedance Z_{OL}. The power receiving unit 222 may be connected to a device, namely a load consuming the received power.

This system is required to meet impedance matching so that the power transmitted from the transmitter 120 to the receiver 220 is not reflected. For impedance matching, an intrinsic impedance Zₒₛ (internal impedance) of the power generation unit 121 and the input impedance Z_{OL} of the power receiving unit 222 are adjusted to optimal value.

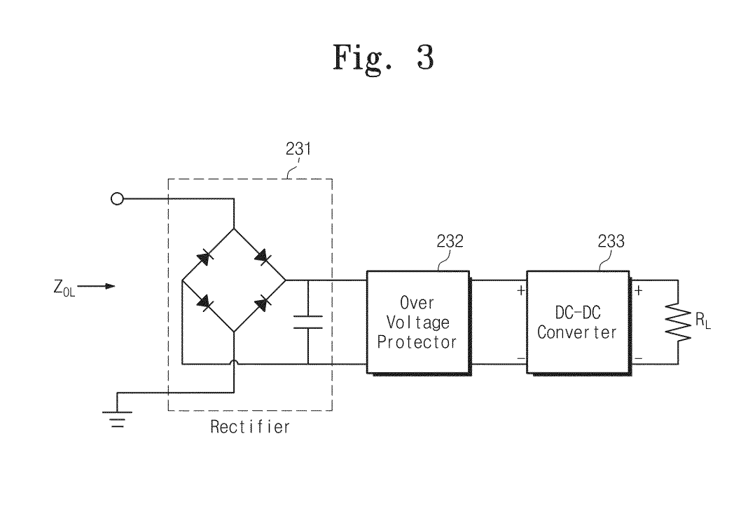

FIG. 3 is a view specifically illustrating the input impedance Z_{OL} illustrated in FIGS. 1 and 2.

Referring to FIG. 3, the input impedance Z_{OL} depends on a rectifier 231, an over voltage protector 232, a DC-DC converter 233, and a load resistor R_{L}.

The rectifier 231 allows a current only in one direction. The rectifier 231 is used for getting DC power from an AC power.

The over voltage protector 232 is a device installed for protecting an apparatus when a over voltage occurs. Also, the over voltage protector 232 keeps the input impedance Z_{OL} at a constant value although resistance of the load resistor R_{L} is changed.

An invention (Korean Patent Application Number: 10-2011-0050767) filed already by the present inventor discloses the over voltage protector 232 specifically. The invention is used as a reference of the present invention, and a detailed description of the over voltage protector 232 is omitted for conciseness.

The DC-DC converter 233 generates a output voltage by stepping up and down the input voltage and provides the output voltage to the load resistor R_{L}.

The load resistor R_{L} receiving power to operate is an equivalent resistor of an electromagnetic device. For example, the load resistor R_{L} may be an equivalent resistor of a mobile phone or an LCD monitor.

According to a typical art, for power transmission, a time division method or a frequency division method has been used. However, in case of the time division method, an electromagnetic device of charging type can be operated but an electromagnetic device of not charging type can not be operated.

Therefore, a frequency division method transmitting power by using different resonant frequencies in respective receivers has been provided. However, since each used frequency needs a different antenna or a coil, the frequency division method has limitation on an antenna structure or the number of receivers.

On the other hand, the wireless power receiver and transmitter according to the present invention can transmit power efficiently to a plurality of receivers at the same time by using one resonant frequency.

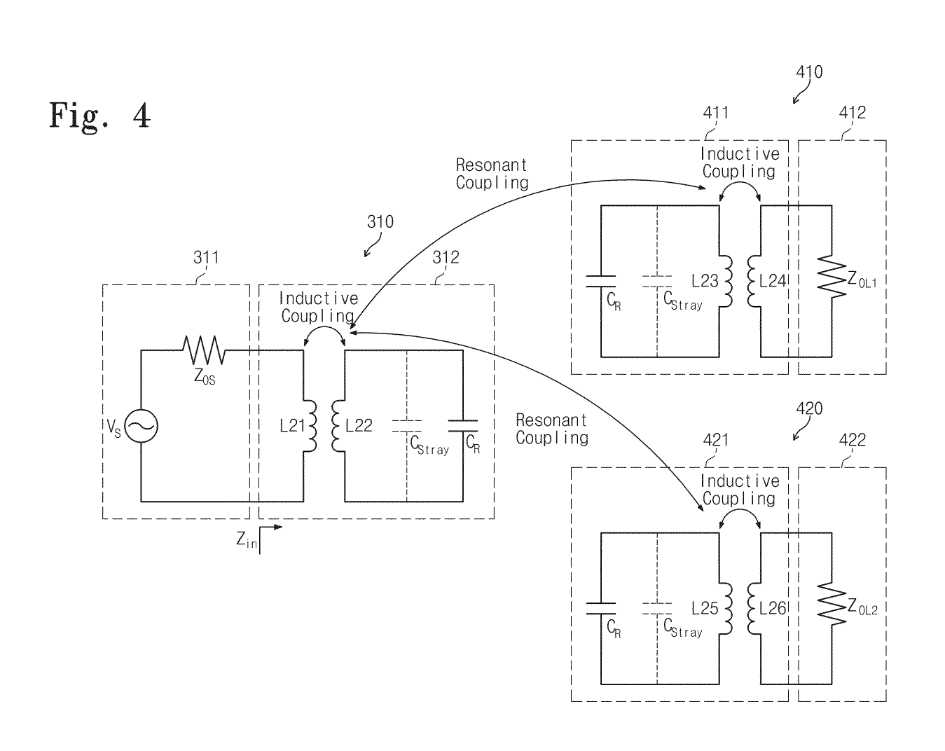

FIG. 4 is a block diagram illustrating a parallel wireless power receiver and transmitter according to an embodiment of the present invention.

Referring to FIG. 4, the wireless power receiver and transmitter includes a transmitter 310, and two receivers (first and second receivers) 410 and 420. In the present embodiment, just two receivers 410 and 420 are illustrated for the convenience of explanation, but the wireless power receiver and transmitter according to the present invention may include more than two receivers. The technical features of the present invention can be also applied to two or more receivers.

The transmitter 310 transmits power to the receivers 410 and 420 at the same time by wireless. The transmitter 310 includes a power generation unit 311, and a transmitting coil unit 312. Each of receivers 410 and 420 includes a receiving coil unit and a power receiving unit. Specifically, the first receiver 410 includes a receiving coil unit 411 and a power receiving unit 412. The second receiver 420 includes a receiving coil unit 421 and a power receiving unit 422.

The power generation unit 311 includes a power source Vₛ and a resistor Zₒₛ. The power generation unit 311 generates power using the power source Vₛ and the generated power is provided to the transmitting coil unit 312.

The transmitting coil unit 312 includes two inductors L21 and L22, and a capacitor C_{R}. Also, the transmitting coil unit 312 may further include a stray capacitor C_{stray} having uncertain capacitance. The transmitting coil unit 312 outputs the received power in the form of a magnetic field through the inductor L21.

The inductor L22 of the transmitting coil unit 312 receives the power from the inductor L21. The inductor L21 and the inductor L22 of the transmitting coil unit 312 are inductively coupled to each other. Therefore, the inductor L21 and inductor L22 may be located a relatively adjacent positions. The inductor L22 of the transmitting coil unit 312 output the received power in the form of a magnetic field.

The inductor L23 of the receiving coil unit 411 in the first receiver 410 and the inductor L25 of the receiving coil unit 421 in the second receiver 420 receive the power from the transmitting coil unit 312.

The transmitting coil unit 312 and the receiving coil units 411 and 421 of the first receiver 410 and the second receiver 420 are resonance-coupled. Therefore, when the transmitting coil unit 312 and the receiving coil units 411 and 421 of the first receiver 410 and the second receiver 420 have the same resonant frequency, highly efficient power transmission is possible. Due to the characteristics of the resonance coupling, a relatively long distance power transmission is possible as compared with the inductive coupling. That is, the inductor L22 of the transmitting coil unit 312 and the inductor L23 of the receiving unit 411 (or the inductor L25 of the receiving coil unit 421) can be located a relatively long distance from each other.

The receiving coil unit 411 of the first receiver 410 includes two inductors L23 and L24, and a capacitor C_{R}. Also, the receiving coil unit 411 may further include a stray capacitor C_{stray} having uncertain capacitance. The inductor L23 of the receiving coil unit 411 receives the power from the transmitting coil unit 312. Here, the receiving coil unit 411 and the transmitting coil unit 312 are resonance-coupled.

The receiving coil unit 411 output the received power in the form of a magnetic field through the inductor L23. The inductor L24 receives the power in the form of a magnetic field. The inductor L23 and the inductor L24 of the receiving coil unit 411 are inductively coupled to each other. Therefore, the inductor L23 and inductor L24 may be located a relatively adjacent positions. The power received by the inductor L14 is provided to the power receiving unit 412.

The power receiving unit 412 includes an input impedance Z_{OL1}. The power receiving unit 412 provides the power received through the inductor L14 to the input impedance Z_{OL1}. The power receiving unit 412 may be connected to a device, namely a load consuming the received power.

The operation of the second receiver 420 is similar to the operation of the first receiver 410. Therefore, a detailed description of the operation of the second receiver 420 is omitted for conciseness.

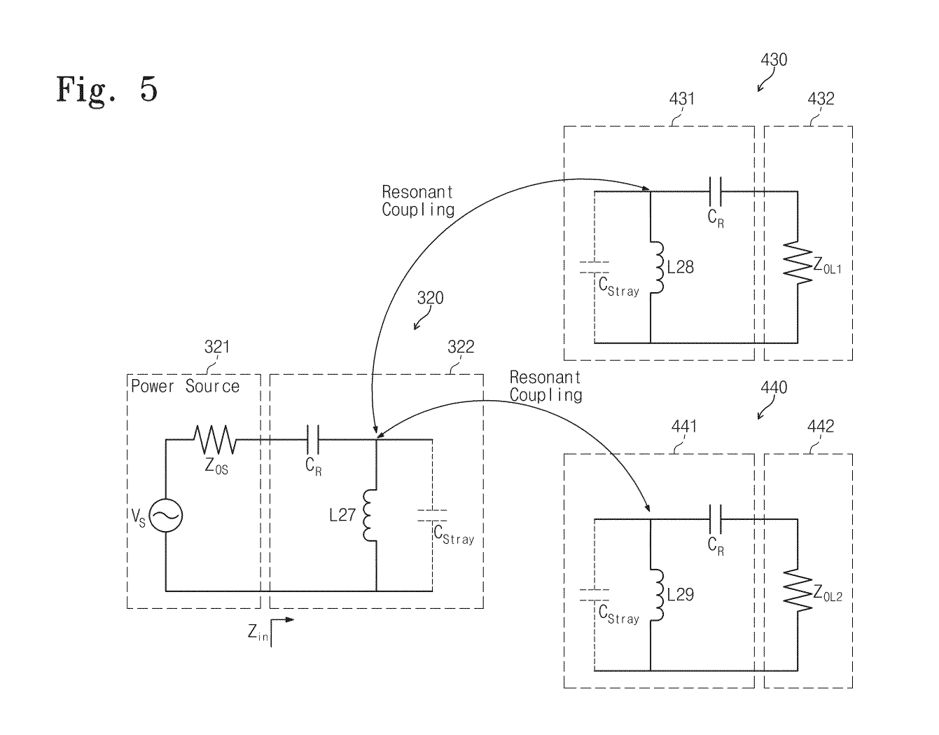

FIG. 5 is a block diagram illustrating a series wireless power receiver and transmitter according to an embodiment of the present invention.

Referring to FIG. 5, the wireless power receiver and transmitter includes a transmitter 320, and two receivers 430 and 440. In the present embodiment, just two receivers 430 and 440 are illustrated for the convenience of explanation, but the wireless power receiver and transmitter according to the present invention may include more than two receivers. The technical features of the present invention are also applied to two more receivers.

The transmitter 320 transmits power to the receivers 430 and 440 by wireless. The transmitter 320 includes a power generation unit 321 and a transmitting coil unit 322. The respective receivers include a receiving coil unit and a power receiving unit. Specifically, the first receiver 430 includes a receiving coil unit 431 and a power receiving unit 432. The second receiver 440 includes a receiving coil unit 441 and a power receiving unit 442.

The power generation unit 321 includes a power source Vₛ and a resistor Zₒₛ. The power generation unit 321 generates power using the power source Vₛ and provides the generated power to the transmitting coil unit 322.

The transmitting coil unit 322 includes an inductor L27 and a capacitor C_{R}. Also, the transmitting coil unit 322 may further include a stray capacitor C_{stray} having uncertain capacitance. The transmitting coil unit 322 outputs the received power in the form of a magnetic field through the inductor L27.

The inductor L28 of the receiving coil unit 431 in the first receiver 430 and the inductor L29 of the receiving coil unit 441 in the second receiver 440 receive the output power from the transmitting coil unit 322.

The transmitting coil unit 322 and the receiving coil units 431 and 441 in the first receiver 430 and the second receiver 440 are resonance-coupled. Therefore, when the transmitting coil unit 322 and the receiving coil units 431 and 441 in the first receiver 430 and the second receiver 440 have the same resonant frequency, highly efficient power transmission is possible. Due to the characteristics of the resonance coupling, relatively long distance power transmission is possible as compared with the inductive coupling. That is, the inductor L27 of the transmitting coil unit 322 and the inductor L28 of the receiving coil unit 431 (or the inductor L29 of the receiving coil unit 441) can be located a relatively long distance from each other.

The receiving coil unit 431 in the first receiver 430 includes the inductor L28 and a capacitor C_{R}. Also, the receiving coil unit 431 may further include a stray capacitor C_{stray} having uncertain capacitance. The inductor L28 of the receiving coil unit 431 receives the output power from the transmitting coil unit 322. Here, the receiving coil unit 431 and the transmitting coil unit 322 are resonance-coupled. The receiving coil unit 431 receives the power that the transmitting coil unit 322 outputs the received power in the form of a magnetic field through the inductor L28. The power received by the inductor L28 is provided to the power receiving unit 432.

The power receiving unit 432 has an input impedance Z_{OL1}. The power receiving unit 432 provides the power received through the inductor L28 to the input impedance Z_{OL1}. The power receiving unit 432 may be connected to a device, namely a load consuming the received power.

The operation of the second receiver 440 is similar to the operation of the first receiver 430. Therefore, a detailed description of the operation of the second receiver 440 is omitted for conciseness

An explanation will now be given with reference to FIGS. 4 and 5 described above

A system is required to meet impedance matching so that power transmitted from the transmitter 310 (320) to the receivers 410 and 420 (430 and 440) is not reflected. For impedance matching, an intrinsic impedance Zₒₛ (internal impedance) of the power generation unit 311 (321), the input impedance Z_{OL1} of the power receiving unit 412 (432) in the first receiver 410 (430), and the input impedance Z_{OL2} of the power receiving unit 422 (442) in the second receiver 420 (440) may be adjusted to optimal values.

Also, for improving power transmission efficiency, the operation frequency of the receiver and transmitter need to be adjusted to optimal values. It is exemplary described below that a transmitter transmits power to a receiver. An optimal frequency and efficiency may be determined through an experiment. If the optimal frequency is f₀, the power transmission efficiency η₀ is defined as:

$${η}_{0} = \frac{{P}_{01}}{{P}_{in}} at {f}_{0}$$

where Pᵢₙ indicates power from a receiver, and P₀₁ indicates power received by a receiver.

Also, power magnitude S₁₁ which can not be transmitted from a transmitter to a receiver on the condition of the optimal frequency and is reflected, is below,

S₁₁≦−10 dB

That is, under the condition of the optimal frequency, power uselessly reflected to a power generator is decreased owing to impedance matching.

It is described above that a transmitter transmits power to a receiver, however, for efficient wireless power transmission, when a transmitter which uses the optimal frequency f₀ transmits power to a plurality of receivers, the power transmission efficiency η₀ is required to be maintained.

Also, for stable wireless power transmission, when power consumption of receivers is changed, the total power transmission efficiency is required to be maintained.

Meanwhile, the transmitter and the receiver of FIGS. 4 and 5 are described according to an embodiment. The transmitter 310 of FIG. 4 may transmit power to the receivers 430 and 440 of FIG. 5, or the transmitter 320 may transmit power to the receivers of FIG. 4.

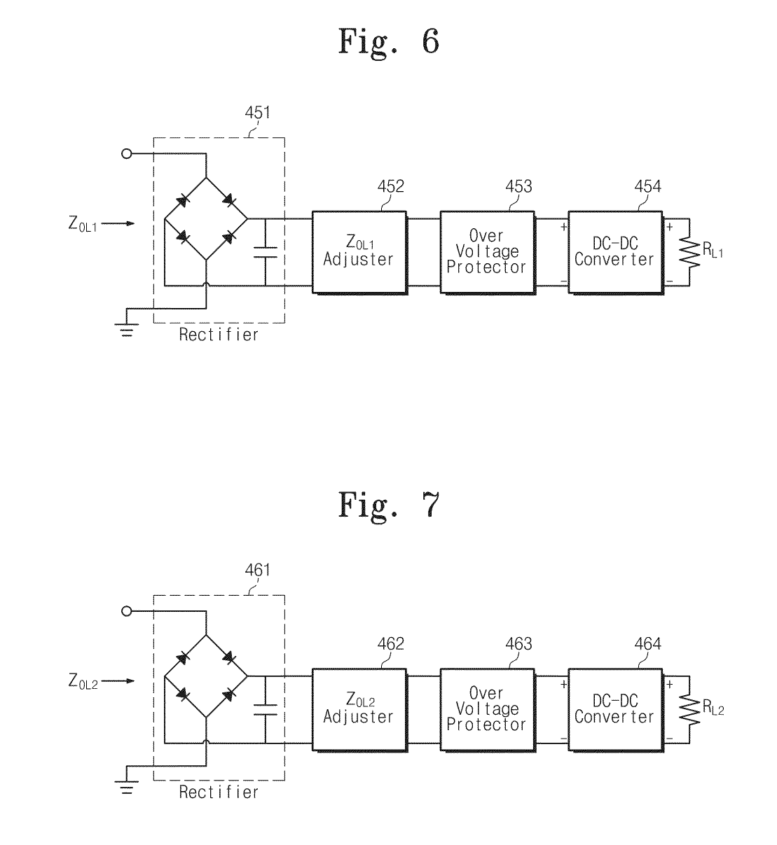

FIG. 6 is a view specifically illustrating an input impedance Z_{OL1} of a first receiver illustrated in FIGS. 4 and 5.

Referring to FIG. 6, the input impedance Z_{OL1} of the first receiver 410 (430) depends on a rectifier 451, an input impedance adjuster 452, an over voltage protector 453, a DC-DC converter 454, and a load resistor R_{L1}.

Since the operations of the rectifier 451, the over voltage protector 453, and a DC-DC converter 454, are similar to those in FIG. 3, detailed descriptions thereof are not given. Also, since a feature of the present invention is to change the input impedance of the receiver, the rectifier 451, the over voltage protector 453, and the DC-DC converter 454 may be omitted according to circumstances.

FIG. 7 is a view specifically illustrating the input impedance Z_{OL2} of the second first receiver illustrated in FIGS. 4 and 5.

Referring to FIG. 7, the input impedance Z_{OL2} in the second receiver 420 (440) depends on a rectifier 461, an input impedance adjuster 462, an over voltage protector 463, a DC-DC converter 464, and a load resistor R_{L2}.

Since the operations of the rectifier 461, the over voltage protector 463, and the DC-DC converter 464 are similar to those in FIG. 3, detailed descriptions thereof are omitted. Also, since a feature of the present invention is to change the input impedance of the receiver, the rectifier 461, the over voltage protector 463, and the DC-DC converter 464 may be omitted according to circumstances.

In FIGS. 6 and 7, R_{L1} and R_{L2} mean equivalent resistors of an electromagnetic device that operates using received power. For example, R_{L1} may be an equivalent resistor of a mobile phone, and R_{L2} may be an equivalent resistor of an LCD monitor. Power consumed by a mobile phone and an LCD monitor may be changed.

According to the present invention, in the case of changing the equivalent resistor, the input impedance is required to be maintained. That is, R_{L1} and Z_{OL1} may mutually be independent, and R_{L2} and Z_{OL2} may mutually be independent.

The over voltage protector 453 (463) keeps the input impedance Z_{OL1} Z_{OL2} at a constant value although resistance of the load resistor R_{L1} (R_{L2}) is changed. An invention (Korean Patent Application Number: 10-2011-0050767) filed already by the present inventor discloses the over voltage protector 453 (463) specifically. Therefore, a detailed description of the over voltage protector 453 (463) is omitted for conciseness.

The present invention provides a method for tuning the input impedance Z_{OL1} and the input impedance Z_{OL2} for transmitting power efficiently and stably to a plurality of the receivers. The input impedance adjuster 452 of FIG. 6 adjusts the input impedance Z_{OL1}. Also, the input impedance adjuster 462 of FIG. 7 adjusts the input impedance Z_{OL2}. As described below, efficient wireless power transmission is possible by adjusting the input impedance in the first receiver 410 (430) and the second receiver 420 (440).

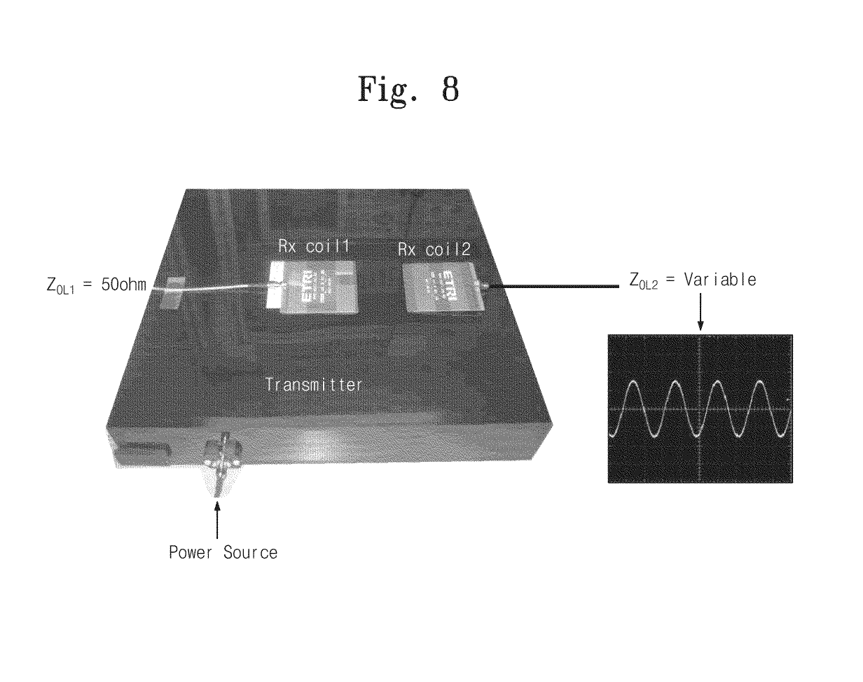

FIG. 8 illustrates a wireless power receiver and transmitter according to an embodiment of the present invention. Referring to FIG. 8, according to the current embodiment of the present invention, the wireless power receiver and transmitter includes a transmitter, a first receiver, and a second receiver. Here, the transmitter and the receiver respectively may include two inductors inductively coupled like in FIG. 4 or one inductor like in FIG. 5.

A power source is input through an input port of the receiver. A transmitting coil is placed in a black box. Two receiving coil units Rx coil 1 and Rx coil 2 are placed on the black box. The receiving coil units are connected to respective power receiving units through cables, respectively.

The case that the input impedance of the first receiver is fixed to 50 ohm and the input impedance of the second receiver is variable is described below

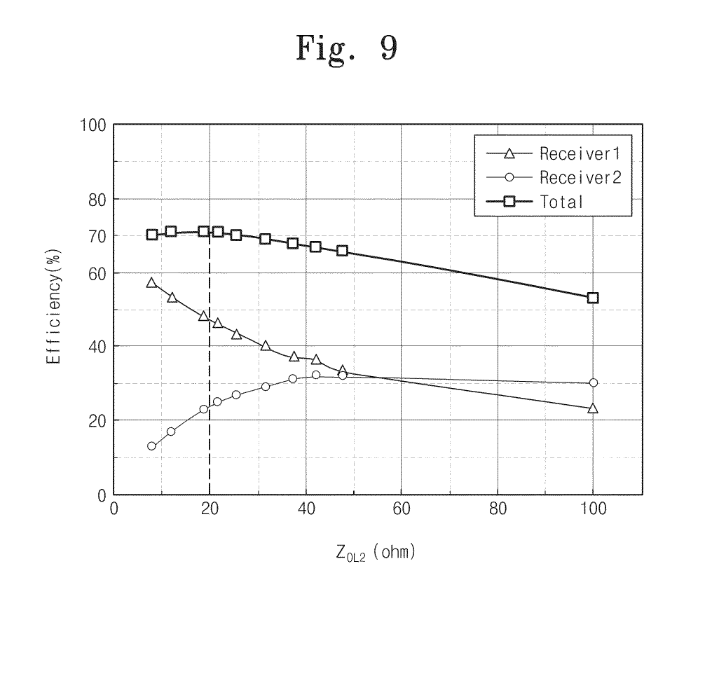

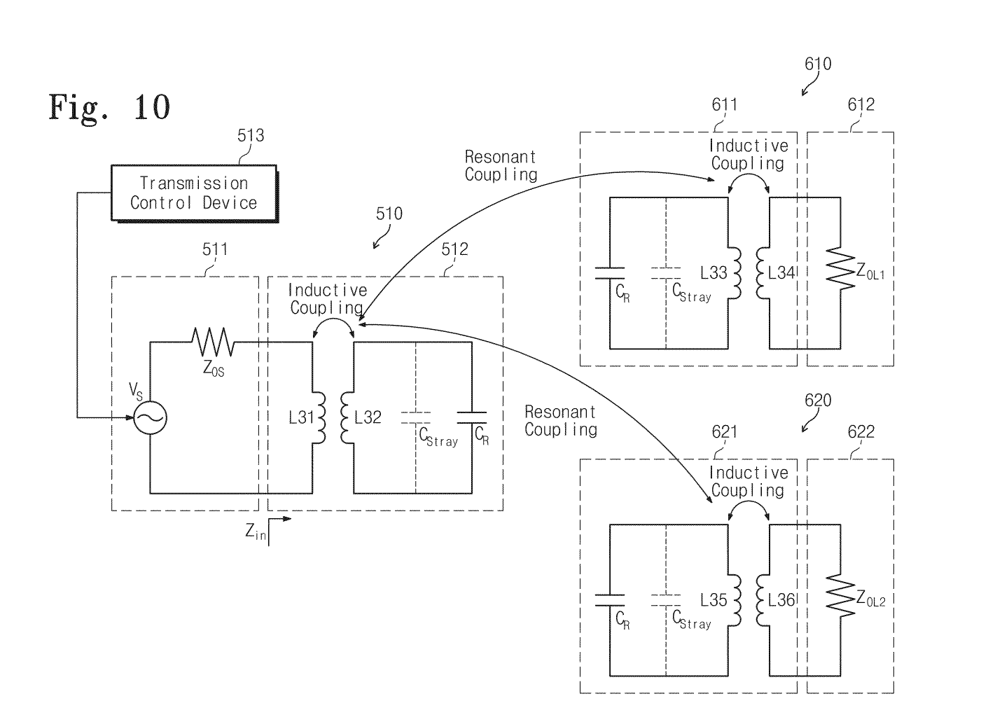

The inventor of the present invention has found that power transmission efficiency is variable according to the input impedances in the second receiver. Referring to FIG. 9, the variation of power transmission efficiency according to the input impedance change in the first receiver and the second receiver is described below

FIG. 9 is a graph illustrating power transmission efficiency measured from the receiver and transmitter of FIG. 8.

As described in FIG. 8, the load of 50 ohm is connected to the first receiver, and while changing the load connected in the second receiver, power transmission efficiency values of the respective receivers are measured.

Referring to FIG. 9, total transmission efficiency is changed according to the input impedance change in the second receiver. That is, when the input impedance is about 20 ohm, total transmission efficiency has maximum value at about 70%. As the input impedance of the second receiver increases more than 20 ohm, total transmission efficiency decreases.

Magnitude of the input impedance in the receiver is determined according to the magnitude of the power consumed by the load resistor in the respective receivers. For example, the input impedance of the receiver including a load resistor consuming much power is lager than the input impedance of the receiver including a load resistor consuming a little power.

As a result, in the case of the two receivers, by adjusting the input impedance of the respective receivers, power can be transmitted stably and efficiently to the receivers at the same time by wireless, and this method can be equally applied to a plurality of receivers.

In the above explanation, resistance of the load resistor of the first receiver is fixed, and resistance of the load resistor of the second receiver is varied for the conciseness of explanation. However, all resistance of the load resistors of the first receiver 410 (430) and the second receiver 420 (440) may be changed in the present invention.

For example, the input impedance of the first receiver may be 40 ohm and the input impedance of the second receiver may be 30 ohm, or the load resistor of the first receiver may be 30 ohm and the load resistor of the second receiver may be 40 ohm. In this way, various combinations are possible.

FIG. 10 is a block diagram illustrating a wireless power receiver and transmitter according to another embodiment of the present invention.

Referring to FIG. 10, the wireless power receiver and transmitter includes a transmitter 510, and two receivers 610 and 620. In the present embodiment, just two receivers 610 and 620 are illustrated for the convenience of explanation, but the wireless power receiver and transmitter according to the present invention may include more than two receivers.

According to the embodiment, the wireless power receiver and transmitter includes the wireless power receiver and transmitter of FIG. 4 and further a transmission control device 513. The transmission control device 513 detects power consumed by a plurality of receivers 610 and 620, and, controls power output by the transmitter 510 according to the detection result.

For example, if the receivers 610 and 620 consume much power, the transmission control device 513 controls that the transmitter 510 outputs much power. On the other hand, if the receivers 610 and 620 consume less power, the transmission control device 513 controls that the transmitter 510 outputs less power. According to output power controlled by the transmission control device 513, power transmission efficiency can increase.

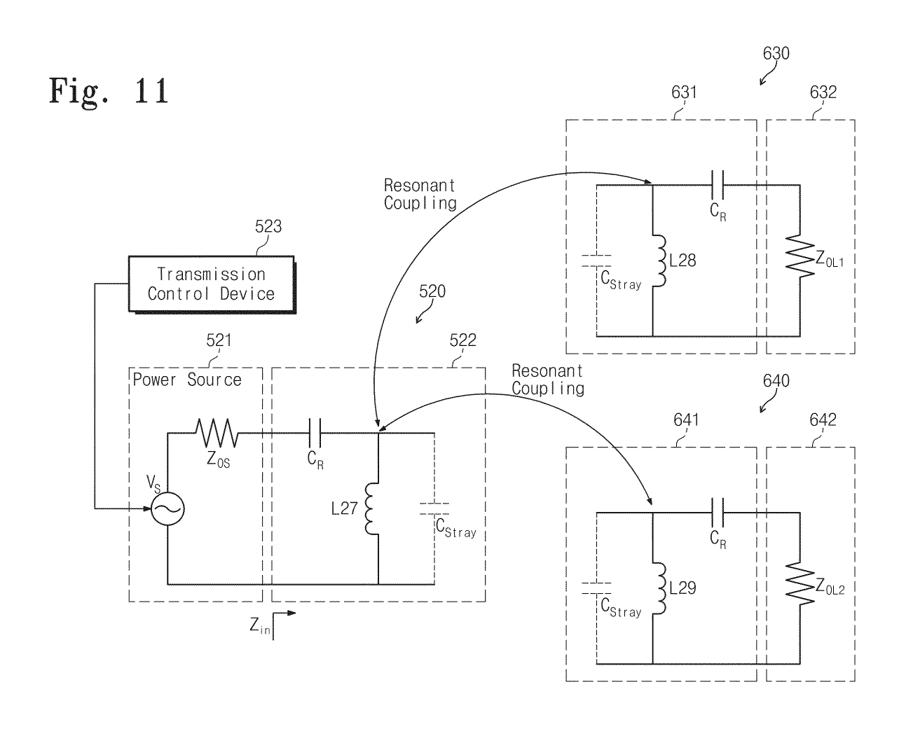

FIG. 11 is a block diagram illustrating a wireless power receiver and transmitter according to another embodiment of the present invention.

Referring to FIG. 11, the wireless power receiver and transmitter includes a transmitter 520, and two receivers 630 and 640. In the present embodiment, just two receivers 630 and 640 are illustrated for the convenience of explanation, but the wireless power receiver and transmitter according to the present invention can include more than two receivers.

According to the embodiment, the wireless power receiver and transmitter includes the wireless power receiver and transmitter of FIG. 5 and further a transmission control device 523. The transmission control device 523 detects power consumed by a plurality of receivers 630 and 640, and controls power output by the transmitter 520 according to the detection result.

For example, if the receivers 630 and 640 consumes much power, the transmission control device 523 controls that the transmitter 520 outputs much power. On the other hand, if the receivers 630 and 640 consume less power, the transmission control device 523 controls that the transmitter 520 outputs less power. According to output power controlled by the transmission control device 523, power transmission efficiency can increase.

Meanwhile, since the transmitter and the receiver of FIGS. 10 and 11 are explained as one example, the receiver 510 of FIG. 10 may transmit power to the receivers 630 and 640 of FIG. 11, or the transmitter 520 of FIG. 11 may transmit power to the receivers 610 and 620 of FIG. 10.

The present invention has been described for the case where each of the transmitter and the receiver includes two inductors (or coils) inductively coupled to each other, and the case where each of the transmitter and the receiver includes one inductor (or coil) connected in series. However, the present invention can be applied to both the cases for transmitting power to a plurality of receivers by wireless.

According to the embodiment of the present invention above, the power transmission efficiency of the wireless power receiver and transmitter can be improved.

It is very obvious to those skilled in the art that the present invention may be modified or changed within the scope or technical feature of the present invention. When considering contents described above, if the modification and change of the present invention is within the scope of the appended claims and the equivalent, the present invention is considered to include the modification and change of this invention.

What is claimed is:

1. A wireless power receiver comprising:
a receiving coil unit receiving power from a transmitter by a resonance coupling method; and
a power receiving unit receiving power from the receiving coil unit to provide the power to a load resistor,
wherein an input impedance of the power receiving unit is adjusted according to power consumed by a plurality of receivers, and
the wireless power receiver receives power at the same time through a plurality of the receivers using one operation frequency.

2. The wireless power receiver of claim 1, wherein the power receiving unit comprises:
an impedance adjuster adjusting the input impedance; and
an over voltage protector keeping the input impedance at a constant value although resistance of the load resistor is changed.

3. The wireless power receiver of claim 2, wherein the impedance adjuster adjusts the input impedance according to power consumed by the load resistor

4. The wireless power receiver of claim 3, wherein the impedance adjuster increases the input impedance as the load resistor consumes more power.

5. The wireless power receiver of claim 3, wherein the impedance adjuster decreases the input impedance as the load resistor consumes less power.

6. The wireless power receiver of claim 1, wherein the receiving coil unit comprises an inductor connected in series.

7. The wireless power receiver of claim 1, wherein the receiving coil unit comprises two inductors inductively coupled to each other for receiving power.

8. A wireless power transmitter comprising:
a power generation unit generating power using a power source; and
a transmitting coil unit transmitting the power at the same time to a plurality of receivers through an operation frequency by a resonance coupling method,
wherein input impedances of the receivers are adjusted according to power consumed by the receivers, respectively.

9. The wireless power transmitter of claim 8, wherein the wireless power transmitter further comprises a transmission control device adjusting power generation by the power source according to a total amount of power consumed by the receivers.

10. The wireless power transmitter of claim 9, wherein the transmission control device increases power generation by the power source as total power consumption of the receivers increases.

11. The wireless power transmitter of claim 9, wherein the transmission control device decreases power generation by the power source as total power consumption of the receivers decreases.

12. The wireless power transmitter of claim 8, wherein the transmitting coil unit comprises an inductor connected in series.

13. The wireless power transmitter of claim 8, wherein the transmitting coil unit comprises two inductors inductively coupled to each other for receiving power.
